(19) United States
(12) Patent Application Publication
(10) Pub. No.: US 2008/0097814 A1
(43) Pub. Date: Apr. 24, 2008

(54) Salon Point of sale

(76) Inventor: James Koustoumbardis, Campbell, CA (US)

Correspondence Address: James Koustoumbardis, 94 Amato Ave., Cambell, CA, 95008, US

(21) Appl. No.: 11/551,245

(22) Filed: Oct. 20, 2006

(51) Int. Cl. G06F 15/02

(52) U.S. Cl. 705/9

(57) ABSTRACT

A solon point of sale user interface, comprising a display operable to display point of sale information, such as hair salon information, for at least one of: a product and a service an augmentable visual presentation of client information. The visual representation augments at least one of: a client's hair style, hair color, hair cut and perm. The display is operable to display product offer information. The solon point of sale user interface may receive client history information and in response display the product offer information. According to one embodiment, the solon point of sale user interface generates product information in response to the client information. According to one embodiment, the solon point of sale user interface generates next appointment information in response to the client information.

### FIELD OF THE INVENTION

The invention relates generally to point of sale devices and more specifically point of sale device to present client information.

### BACKGROUND OF THE INVENTION

In recent years there have evolved service companies servicing merchants that accept most credit and debit cards and can even authorize check payments. These services certainly help both the consumer and merchant and have facilitated more proximity service growth. However, these point of sale devices (POS) merely facilitate payment but do not easily and adequately inform the salon agent of options for the sale of goods and services to the customer.

### BRIEF DESCRIPTION OF THE DRAWINGS

The present invention is illustrated by way of example and not limitation in the accompanying figures, in which like reference numerals indicate similar elements, and in which:

FIG. 1 is block diagram of a salon point of sale device in accordance with an exemplary embodiment of the present invention;

FIG. 2 is a block diagram of a retail user interface according to one embodiment of the invention;

FIG. 3 is a block diagram of a retail user interface according to another embodiment of the present invention and

FIG. 4 is a block diagram of a retail user interface according to yet another embodiment of the present invention.

### DETAILED DESCRIPTION OF THE PREFERRED EMBODIMENTS

A solon point of sale user interface, comprising a display operable to display point of sale information, such as hair salon information, for at least one of: a product and a service an augmentable visual presentation of client information. The visual representation augments at least one of: a client's hair style, hair color, hair cut and perm. The display is operable to display product offer information. The solon point of sale user interface may receive client history information and in response display the product offer information. According to one embodiment, the solon point of sale user interface generates product information in response to the client information. According to one embodiment, the solon point of sale user interface generates next appointment information in response to the client information.

Among other advantages, the solon point of sale user interface efficiently facilitates transactions in hair salons. The user interface acts as an expert system to easily and automatically without user interaction allow a salon stylist or agent to recommend goods and services as an expert salon stylist. Furthermore, the solon point of sale user interface facilitates increases salon revenue in increases customer satisfaction. The solon point of sale user interface is an improved order fulfillment system. The system is provided with improved data entry system for selecting items for purchase by a customer, and an improved item collection terminal and order delivery system. The terminal to be used for collecting of items is provided with an audio and/or video presentation means which are used to provide assistance to the to terminal user.

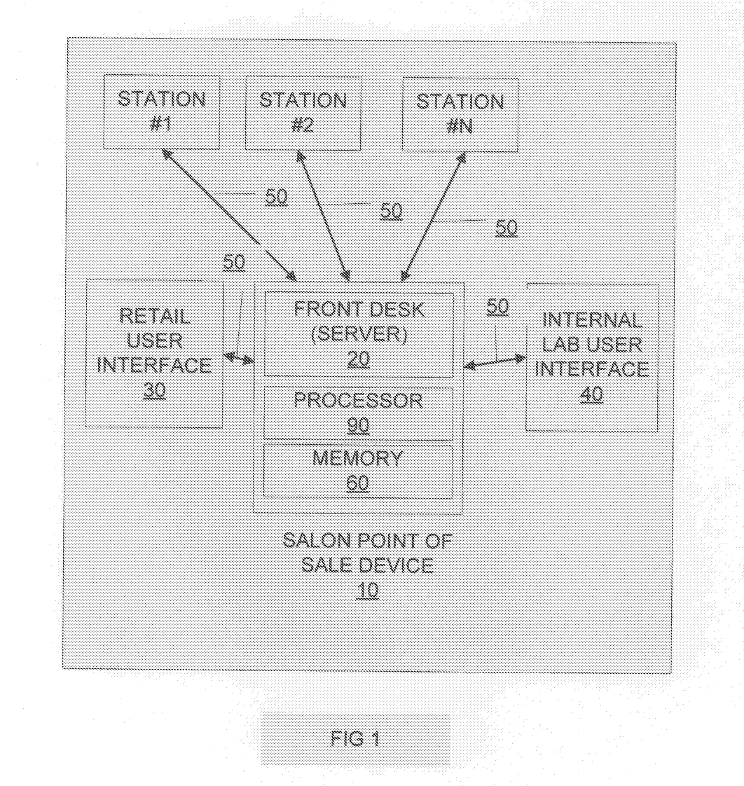

FIG. 1 is a block diagram of a salon point of sale device according to one embodiment. The salon point of sale device #10 includes a server 20, a retail user interface 30, internal user lab interface 40 and station 1,2, . . . N.

The software & hardware within the server 20 are able to produce specific information corresponding to each and every client visit. According to one embodiment, a client will be able to hold a PDA in hand and walk from station to station and place the PDA in a cradle and be able to look at information specific to her or his needs, flashing ads will be based on client history and future needs/e.g. appointments and new information on retail needs client will be able to point on the screen for detail information shop for items and retrieve at front reception. According to one example, a wireless router with specific IP address for each individual PDA this information is then stored in a main sever or main frame and the system could support any # of suitable PDA. The wireless router may be part of the server 20.

Server 20 may be a computer, a personal computer, a computer server or any suitable computer device. The server may include memory 60 containing client information as mentioned elsewhere and instructions forming software POS applications executable by a processor. The memory 60 may include fewer or more applications and sub-applications. For example, the memory may be, a hard disk drive, a distributed disk drive system, random access memory (RAM), read-only memory (ROM), optical memory or any suitable storage-medium located locally or remotely, such as via a server or distributed memory, and may be accessible via link(s) 30 by a wide area network (WAN), a local area network (LAN), a switching system or any suitable network element via the Internet, a wireless wide access network (WWAN), a wireless local area network (WLAN) (such as but not limited to a WiFi or WiMAX network), such as but not limited to a wireless communication network, an infrared communication network, a satellite communication network or any suitable communication interface or network. According to an alternative embodiment, instead of a wired or wireless link 50, flash memory cards may convey the relevant information. For example, a customer may present a memory card, such as a smart card, credit card, or any other suitable POS memory device for insertion into user interface 30, 40 a station 1, 2, . . . N.

Processor 90 may be one or more suitably programmed processors, such as a microprocessor, a microcontroller or a digital signal processor (DSP), and, therefore, includes associated memory, such as memory 60, which contains instructions that, when executed, causes the processor 90 to carry out the operations described herein. In addition, the processor 90, as used herein, may include discrete logic, state machines or any other suitable combination of hardware, software, middleware and/or firmware.

According to one embodiment, the POS application may be a software program operating on the processor 90 in a computer that is part of a network of computers to perform a variety of functions, among other things, to determine which of the available applications to establish communication with. Similarly, a POS application integrator may represent a software program or any other suitable software program operating on processor 90 to facilitate communication between the integration and retail user interface 30, the internal lab user interface 40, stations 1, 2, . . . N and the various applications in memory 60. Additionally, the retail user interface 30, the internal lab user interface 40, and stations 1, 2, . . . N may each represent a software program operating on processor 90 or on their own respective processors. In addition, the retail user interface 30, the internal lab user interface 40, and stations 1, 2, . . . N as used herein, can also include discrete logic, state machines or any other suitable combination of computer, hardware, software, and/or firmware.

A solon point of sale application, communicates and displays point of sale information, such as hair salon information, for at least one of: a product and a service an augmentable visual presentation of client information. The visual representation augments at least one of: a client's hair style, hair color, hair cut and perm. The retail user interface 30, the internal lab user interface 40, and/or stations 1, 2, . . . N are operable to display product offer information. The retail user interface 30, the internal lab user interface 40, and/or stations 1, 2, . . . N may receive client history information and in response display the product offer information. According to one embodiment, the solon point of sale user interface 10 generates product information in response to the client information. According to one embodiment, the solon point of sale user interface 10 generates next appointment information in response to the client information. The solon point of sale user interface may be a display operable to display point of sale information, such as hair salon information, for at least one of: a product and a service an augmentable visual presentation of client information.

The retail user interface 30, the internal lab user interface 40, and stations 1, 2, . . . N may be presented on a display for receiving and displaying integrated information. Further, a user may provide interactive user response information to the retail user interface 30, the internal lab user interface 40, and/or stations 1, 2, . . . N via the integrated user interface software. The integrated user interface software may be a graphical user interface (GUI), a multifunctional GUI or any suitable user interface. The integrated user interface software is integrated in that it is a single level user interface that displays output from a plurality of applications that have been selected for use at a particular stage in the transaction. Therefore, according to this example, there is no need to toggle between applications because all the information is shown in a single level.

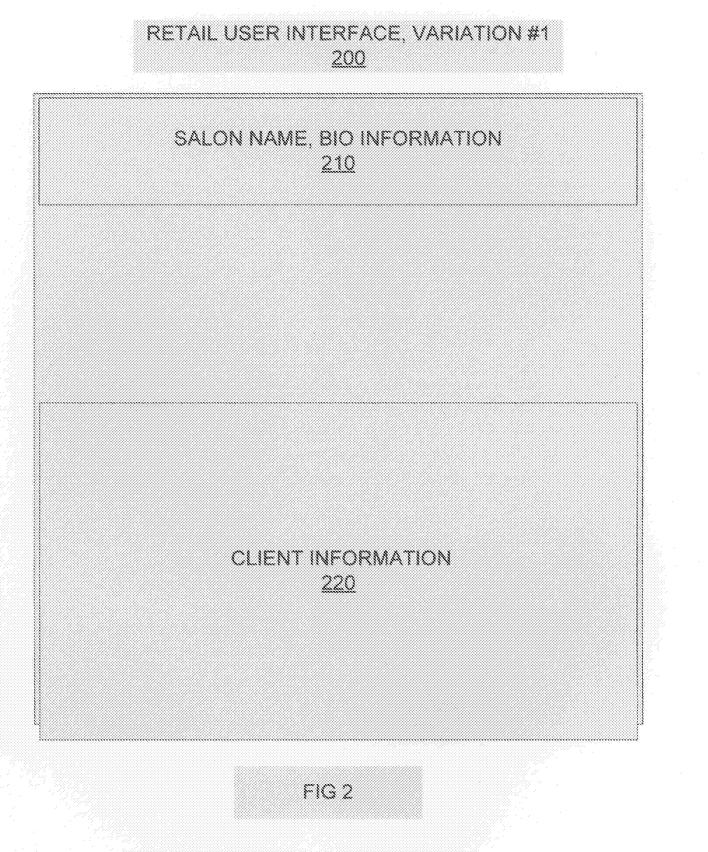

FIG. 2 is a block diagram of a retail user interface 30 according to one embodiment of the invention. The retail user interface 30 displays salon name and/or bio information 210 and client information 220. Bio information may include, hair color, style, age, texture, percentage of gray, and/or any suitable information to facilitate the technical or internal aspects of a client's needs. Client information 220 may include name, phone number, email address, home address, beverage choice, and any other suitable non-technical or external client information. According to this embodiment, the salon name and/or bio information 210 occupies a relatively larger area of the retail user interface 300.

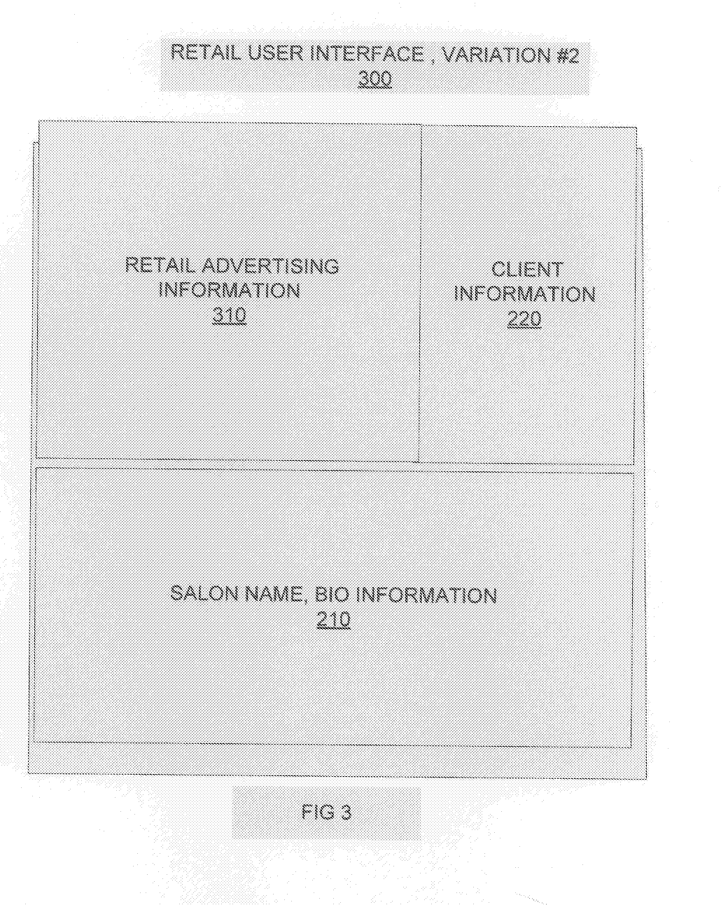

FIG. 3 is a block diagram of a retail user interface according to another embodiment of the present invention. According to this embodiment, retail advertising information 310 is displayed in addition to the information from FIG. 2. Retail advertising information 310 is a recommended or suggested prescription for a client's needs.

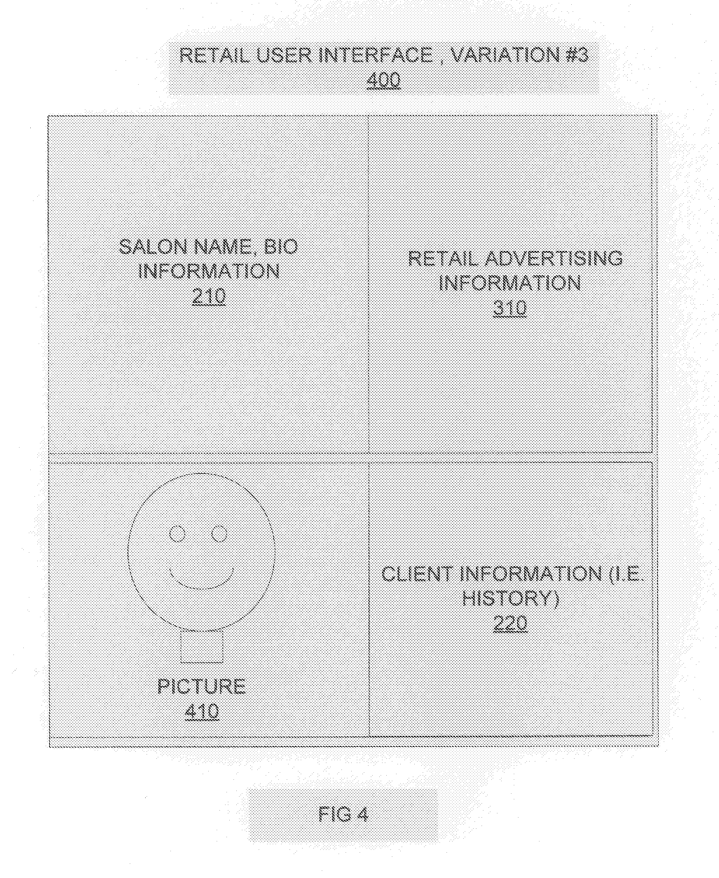

FIG. 4 is a block diagram of a retail user interface according to yet another embodiment of the present invention. According to this embodiment, picture information 410 is displayed in addition to the information from FIG. 3. Picture information 410 includes desired result, previous look, current look, future look or any suitable picture. The picture 410 may propose multiple different looks that provide an image to better facilitate a client's desired selection. The picture information 410 may be a still image, a video, and/or a morphing of images. For example, the picture 410 may lead to the selection of recommend goods and services as part an expert salon stylist.

Among other advantages, the solon point of sale user interface 10 efficiently facilitates transactions in hair salons. The solon point of sale user interface 10 acts as an expert system to easily and automatically, and without user interaction allow a salon stylist or agent to recommend goods and services as an expert salon stylist. Furthermore, the solon point of sale user interface 10 increases salon revenue and increases customer satisfaction. The solon point of sale user interface 10 is an improved order fulfillment system. The system is provided with improved data entry for selecting items for purchase by a customer, and an improved item collection terminal and order delivery system. The terminal to be used for collecting of items is provided with an audio and/or video presentation means which are used to provide assistance to the to terminal user.

In an alternative embodiment, the server 20 prompts the user interface 30, 40, 1, 2, . . . N to display customer specific data and external advertising messages. For instance, if a customer comes in, then the system may recommend a style cut based on previous purchases. The system may even provide a visual representation of what the style cut would look like by overlaying the hair cut over the customer's face via alignment and overlaying techniques known in the art. Alternatively, on their birthday the store could offer the customer a glass of wine and chocolate cupcake. Alternatively, a local hair salon could send a message to all consumers who previously purchased a particular high-end beauty product.

It should be understood that implementation of other variations and modifications of the invention and its various aspects will be apparent to those with ordinary skill in the art, and that the invention is not limited by this specific embodiment described. It is therefore contemplated to cover the present invention and any and all modifications, variations or equivalents that fall within the spirit and scope of the basic underlying principles disclosed and claimed herein.

What is claimed is:

1. A solon point of sale user interface, comprising:
a display operable to display point of sale information for at least one of: a product and a service; and
an augmentable visual presentation of client information.

2. The point of sale user interface of claim 1 wherein the point of sale information corresponds with hair salon information.

3. The point of sale user interface of claim 1 wherein the visual representation augments at least one of: a client's hair style, hair color, hair cut, perm, a still image, a video and a morphing of images.

4. The point of sale user interface of claim 1 wherein the display is operable to display product offer information.

5. The point of sale user interface of claim 4 further comprising receiving client history information and in response display the product offer information.

6. The point of sale user interface of claim 1 further comprising generating product information in response to the client information.

7. The point of sale user interface of claim 1 further including generating next appointment information in response to the client information.

8. A machine readable medium containing instructions executable by one or more processor, operable to:
display point of sale information for at least one of: a product and a service; and
display augmentable client information.

9. The medium of claim 8, wherein the point of sale information corresponds with hair salon information.

10. The medium of claim 8 wherein the visual representation augments at least one of: a client's hair style, hair color, hair cut and perm.

11. The medium of claim 8 wherein the display is operable to display product offer information.

12. The medium of claim 8 further comprising receiving client history information and in response display the product offer information.

13. The medium of claim 8 further including generating product information in response to the client information.

14. The medium of claim 8 further including generating next appointment information in response to the client information.

15. A method comprising:
displaying salon point of sale information for at least one of: a product and a service
displaying augmentable client information.

16. The method of claim 15 wherein the point of sale information corresponds with hair salon information.

17. The method of claim 15 wherein the visual representation augments at least one of: a client's hair style, hair color, hair cut, perm, a still image, a video and a morphing of images.

18. The method of claim 15 wherein the display is operable to display product offer information.

19. The method of claim 15 further comprising receiving client history information and in response display the product offer information.

20. The method of claim 15 further comprising generating product information in response to the client information.

21. The method of claim 15 further including generating next appointment information in response to the client information.
